(19) United States
(12) Patent Application Publication
(10) Pub. No.: US 2026/0322718 A1
(43) Pub. Date: Oct. 15, 2026

(54) METHOD AND SYSTEM FOR MANAGING DELIVERABILITY OF SERVICES BY EDGE COMPUTING NODES

(71) Applicant: Telecom Italia S.p.A., Milano (IT)

(72) Inventors: Maurizio DE PAOLA, Torino (IT); Marino URSO, Ugento (LE) (IT)

(73) Assignee: Telecom Italia S.p.A., Milano (IT)

(21) Appl. No.: 19/482,246

(22) PCT Filed: Apr. 23, 2024
(86) PCT No.: PCT/EP2024/061059

§ 371 Date: Nov. 7, 2025

(30) Foreign Application Priority Data
May 9, 2023 (IT) 102023000009201

(51) Int. Cl. H04L 43/0811; H04L 43/50; H04L 67/10

(52) U.S. Cl. CPC H04L 43/0811; H04L 43/50; H04L 67/10

(57) ABSTRACT

A method for managing service deliverability to a mobile connectable device within a geographic area covered by a wireless communication network having multiple edge computing nodes. The method includes identifying a first edge computing node connected to the device, transmitting test request messages to monitor connectivity as the device moves, and measuring connection parameters indicative of connection quality. Upon failure to receive a test reply from the first node, a second edge computing node is identified. Test requests are transmitted to both the first and second nodes to determine whether a temporary connectivity failure has occurred with the first node or whether service deliverability has transferred to the second node due to device movement. The method distinguishes between temporary failures where service remains deliverable by the first node and permanent failures requiring handover to the second node.

### TECHNICAL FIELD

The present disclosure generally relates to the communication network field. More particularly, the present disclosure relates to a method and system for managing deliverability of services (for example, to ensure service continuity or service availability) by edge computing nodes.

### BACKGROUND ART

The advent of new generation mobile communications networks (such as 4G and 5G mobile communication networks, as well as emerging 6G mobile communication networks) has led to implementation of edge computing. Edge computing is a distributed computing architecture that brings computation and data storage closer to the sources of data.

In a typical implementation, edge computing platforms are distributed over a geographic area covered by a mobile communication network so as to be located close or relatively close to network elements of a core network of the mobile communication network where data traffic is originated/terminated (such as the Packet Data Network Gateway (PGW) for a 4G mobile communication network, and the User Plane Function (UPF) for a 5G mobile communication network).

A common edge computing platform may comprise respective edge computing nodes (or edge servers) each one configured to deliver one or more services: for each service, the edge server(s) configured to deliver that service is (are) replicated over the edge computing platforms within the geographic area.

Addressing the appropriate edge server for the delivery of a service is an issue.

WO2020229496 discloses an active test system for a mobile IoT network providing connectivity and services to mobile IoT (MIoT) devices of low power wide area (LPWA) technologies. The test system has at least one test probe connected to the MIOT network via an LTE-Uu interface and/or at least one test probe connected to the MIOT network via an S1 interface. A central test unit is connected to the at least one test probe via a wireless backhaul network or a fixed IP network. A SIM multiplexer is provided to transfer SIM data to the at least one test probe in test fields.

### SUMMARY

The Applicant has observed that none of the solutions known in the art is capable of efficiently addressing the appropriate edge server for the delivery of a service, especially in mobility scenarios (i.e., where connectable devices connect to the edge server for receiving the service and are movable within the geographic area), and in real-time scenarios (such as in Vehicle-to-everything (V2X) applications), where low latency and high speed of identification of the appropriate server are essential to ensure service continuity. Examples of real-time scenarios include, but are not limited to, self-driving vehicles with information received from the mobile communication network.

According to the Applicant, the solutions known in the art (such as the solution disclosed in WO2020229496) comprise conventional end-to-end tests where data packet exchanges take place to and from a server.

The Applicant is aware of network addressing solutions (such as the “Anycast” solution) in which a single destination IP address is shared by the edge servers configured to deliver a same service, however these solutions involve high network addressing complexity in practical scenarios of coexistence of different wireless communication network operators (especially, but not limited to, cross-country scenarios in which two or more edge servers are located in different countries).

The Applicant is also aware of DNS-based network addressing solutions in which each edge server is associated with a respective centralized DNS. However, these solutions may affect overall connection times towards the appropriate edge server. Moreover, these solutions do not guarantee that real connections are established.

In view of the above, the Applicant has devised a method and system for managing the deliverability of services (for example, to ensure service continuity or service availability) by edge servers. Particularly, the Applicant has devised a method and system for monitoring a connectivity status between a connectable device and an edge server (for example, in order to assess connectivity presence and quality, and determine possible connectivity absences and causes thereof), and addressing the appropriate edge server based on the monitored connectivity status.

One or more aspects of the present disclosure are set out in the independent claims, with advantageous features of the same disclosure that are indicated in the dependent claims, whose wording is enclosed herein verbatim by reference (with any advantageous feature being provided with reference to a specific aspect of the present disclosure that applies mutatis mutandis to any other aspect thereof).

An aspect of the present disclosure relates to a method for managing the deliverability of a service to a connectable device moving or movable within a geographic area.

According to an embodiment, the geographic area is covered by a wireless communication network and comprises a plurality of edge computing nodes for the delivery of the service.

According to an embodiment, the method comprises performing the following steps a)-f₂), or at least a subset thereof:
a) identifying a first one of the plurality of edge computing nodes which the connectable device is connectable to;
b) transmitting, through the wireless communication network, a test request message to the first edge computing node to check if the connectable device is still connectable to the first edge computing node as a result of the connectable device moving or being movable within the geographic area;
   c₁) if a test reply message is received from the first edge computing node in response to the test request message, measuring at least one connection parameter indicative of a quality of the connection between the connectable device and the first edge computing node, and performing step b);
   c₂) if no test reply message is received from the first edge computing node in response to the test request message,
d) identifying a second one of the plurality of edge computing nodes which the connectable device is connectable to instead of the first edge computing node as a result of the connectable device moving or being movable within the geographic area;
e) transmitting a first test request message to the first edge computing node and a second test request message to the second edge computing node, and
   f₁) if a first test reply message is received from the first edge computing node in response to the first test request message, determining that a first connectivity failure temporarily affected the connection to the first edge computing node whereby the service is still deliverable by the first edge computing node, and providing an indication of said first connectivity failure; or
   f₂) if a second test reply message is received from the second edge computing node in response to the second test request message, determining that a second connectivity failure has affected the connection to the first edge computing node due to service deliverabilty being passed from the first edge computing node to the second edge computing node, and providing an indication of said second connectivity failure.

According to an embodiment, step f₁) further comprises performing step b).

According to an embodiment, step f₂) further comprises performing step b) with the second edge computing node acting as the first edge computing node.

According to an embodiment, the at least one connection parameter comprises one or more among latency, jitter and throughput of the first edge computing node.

According to an embodiment, the latency of the first edge computing node is determined based on a time between transmission of the test request message and reception of the test reply message.

According to an embodiment, said providing an indication of said first connectivity failure comprises providing an indication of a duration of said first connectivity failure based on a time between a last test reply message received from the first edge computing node and reception of the first test reply message.

According to an embodiment, said providing an indication of said second connectivity failure comprises providing an indication of a duration of said second connectivity failure based on a time between a last test reply message received from the first edge computing node and reception of the second test reply message.

According to an embodiment, the method further comprises, if no first test reply message from the first edge computing node is received in response to the first test request message, and no second test reply message from the second edge computing node is received in response to the second test request message, performing step e).

According to an embodiment, step c₁) further comprises storing the measured at least one connection parameter together with position data indicative of a position of the connectable device and one or more measured radio parameters of the wireless communication network in that position.

According to an embodiment, step f₁) further comprises storing the indication of said first connectivity failure together with the position data and with the one or more measured radio parameters.

According to an embodiment, step f₂) further comprises storing the indication of said second connectivity failure together with the position data and with the one or more measured radio parameters.

According to an embodiment, at least one between said identifying a first one of the plurality of edge computing nodes and said identifying a second one of the plurality of edge computing nodes is based on the stored measured at least one connection parameter, the stored indications of said first connectivity failures, the stored indications of said second connectivity failures, and a current position of the connectable device within the geographic area.

According to an embodiment, at least one between said identifying a first one of the plurality of edge computing nodes and said identifying a second one of the plurality of edge computing nodes is based on a Tracking Area Code associated with the current position of the connectable device within the geographic area.

According to an embodiment, at least one among the test request and reply messages, the first test request and reply messages, and the second test request and reply messages comprise Internet Control Message Protocol (ICMP) packets.

According to an embodiment, at least one among transmission of the test request message and reception of the test reply message, transmission of the first test request message and reception of the first test reply message, and transmission of the second test request message and reception of the second test reply message is performed based on PING protocol.

Another aspect of the present disclosure relates to a connectable device.

According to an embodiment, the connectable device is movable within a geographic area covered by a wireless communication network and comprising a plurality of edge computing nodes for the delivery of a service to the connectable device.

According to an embodiment, the connectable device is configured to perform the following steps a)-f₂):
a) identifying a first one of the plurality of edge computing nodes which the connectable device is connectable to;
b) transmitting, through the wireless communication network, a test request message to the first edge computing node to check if the connectable device is still connectable to the first edge computing node as a result of the connectable device moving or being movable within the geographic area;
   c₁) if a test reply message is received from the first edge computing node in response to the test request message, measuring at least one connection parameter indicative of a quality of the connection between the connectable device and the first edge computing node, and performing step b);
   c₂) if no test reply message is received from the first edge computing node in response to the test request message,
d) identifying a second one of the plurality of edge computing nodes which the connectable device is connectable to instead of the first edge computing node as a result of the connectable device moving or being movable within the geographic area;
e) transmitting a first test request message to the first edge computing node and a second test request message to the second edge computing node, and
   f₁) if a first test reply message is received from the first edge computing node in response to the first test request message, determining that a first connectivity failure temporarily affected the connection to the first edge computing node whereby the service is still deliverable by the first edge computing node, and providing an indication of said first connectivity failure; or
   f₂) if a second test reply message is received from the second edge computing node in response to the second test request message, determining that a second connectivity failure has affected the connection to the first edge computing node due to service deliverabilty being passed from the first edge computing node to the second edge computing node, and providing an indication of said second connectivity failure.

### BRIEF DESCRIPTION OF THE DRAWINGS

These and other features and advantages of the disclosure will be made apparent by the following description of some exemplary and non-limitative embodiments thereof. For its better intelligibility, the following description should be read making reference to the attached drawings, wherein:

FIG. 1 schematically shows a system according to embodiments of the present disclosure;

FIG. 2 schematically shows main modules of the system of FIG. 1 according to embodiments of the present disclosure, and

FIG. 3 shows the schematic steps of a method implemented by the system according to embodiments of the present disclosure.

### DETAILED DESCRIPTION OF EXEMPLARY EMBODIMENTS

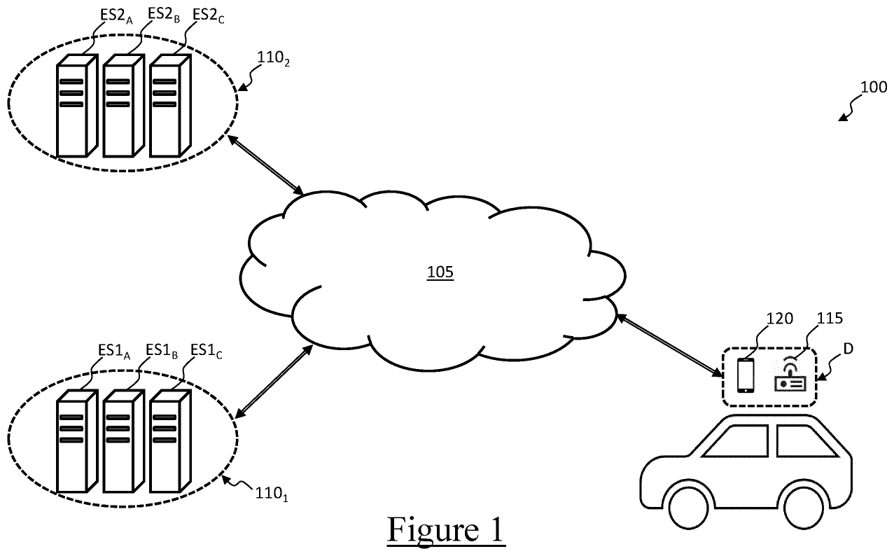

With reference to the drawings, FIG. 1 schematically shows a system 100 according to embodiments of the present disclosure.

In the following, when one or more features of the system 100 (and of a method implemented by it) are introduced by the wording “according to an embodiment”, they are to be construed as features additional or alternative to any features previously introduced, unless otherwise indicated and/or unless there is evident incompatibility among feature combinations that is immediately apparent to the person skilled in the art.

In the following, the terms “node”, “module”, “platform” and “unit” are intended to emphasize functional (rather than implementation) aspects thereof. Without losing generality, each node and/or module and/or platform and/or unit of the system 100 may be implemented by software, hardware, and/or a combination thereof. In addition, each node and/or module and/or platform and/or unit of the system 100 (or at least a subset thereof) may also reflect, at least conceptually, physical structures of the system 100 (or at least of one or more portions thereof).

According to an embodiment, the system 100 comprises a wireless communication network 105. According to an embodiment, the wireless communication network 105 provides radio coverage over a corresponding geographic area. According to an embodiment, the wireless communication network 105 may be a mobile communication network, such as a 4G mobile communication network or a 5G mobile communication network. Without losing generality, the principles of the present disclosure may be applied when considering other wireless communication networks (for example, the emerging 6G mobile communication networks and/or WI-FI communication networks).

According to an embodiment, the system 100 comprises, within the geographic area, a plurality of edge computing platforms for delivering one or more services. For the purposes of the present disclosure, edge computing is a distributed computing architecture that brings computation and data storage closer to the sources of data. According to an embodiment, the plurality of edge computing platforms are geographically distributed over the geographic area. According to an embodiment, the plurality of edge computing platforms are geographically distributed over the geographic area so as to be located close or relatively close to network elements of the core network of the wireless communication network 105 where data traffic is originated/terminated (such as the Packet Data Network Gateway (PGW) for a 4G mobile communication network, and the User Plane Function (UPF) for a 5G mobile communication network).

In FIG. 1, two edge computing platforms 110₁,110₂ are depicted for ease of illustration. In the following, whenever the edge computing platforms are mentioned, reference is intended to be made to the plurality of edge computing platforms over the geographic area (unless otherwise indicated by referring to the edge computing platforms 110₁,110₂ of the exemplary illustrated embodiment).

According to an embodiment, each edge computing platform is configured to deliver one or more services to a connectable device D moving or movable within the geographic area, when the connectable device D requests (or is enabled to reception of) the services (or at least a subset thereof) and is connectable (i.e., capable of making a connection) to the edge computing platform with a quality of connection that is compatible with the requested/enabled service(s) (as better discussed in the following).

According to an embodiment, each edge computing platform comprises respective one or more (for example, a respective plurality of) edge computing nodes (or edge servers) each one configured to deliver one or more services. Without losing generality, each edge server may be a physical machine or a virtualized machine.

According to an embodiment, for each service, the edge server(s) configured to deliver that service is (are) replicated over the plurality of edge computing platforms within the geographic area. In the exemplary (and simplified) illustrated embodiment, each edge computing platform 110₁,110₂ comprises a respective first edge server ES1_{A}, ES2_{A} configured to deliver a first service (referred to as service A), a respective second edge server ES1_{B}, ES2_{B} configured to deliver a second service (referred to as service B), and a respective third edge server ES1_{C}, ES2_{C} configured to deliver a third service (referred to as service C).

An example of service includes, but is not limited to, a warning to a running vehicle of a dangerous situation (for example, the presence of crossing pedestrians at a short distance from the vehicle).

Another example of service includes, but is not limited to, a driving phase of a self-driving vehicle (such as an overtaking phase or a parking phase).

According to an embodiment, the connectable device D comprises an operative device capable of running software applications associated with the services, and a connection device having connection capabilities to the wireless communication network 105 and configured to be communicably coupled to the operative device (e.g., through a dedicated wired or wireless communication channel) to allow connection of the operative device to the wireless communication network 105 (and, hence, to the edge computing platforms) through the connection device.

An example of an operative device comprises, but is not limited to, an OBU (“On Board Unif”) device, such as the OBU device 115. In the exemplary considered embodiment, the OBU device 115 is associated with a vehicle, although this should not be construed limitatively.

An example of a connection device comprises, but is not limited to, a mobile device (e.g., a smartphone), such as the mobile device 120. Therefore, in this embodiment the OBU device 115 and the mobile device 120 are configured to interact/cooperate to each other to act, as a whole, as the connectable device D. Thus, in this embodiment, the mobile device 120 is configured to perform both its conventional activities (including, but not limited to, execution of applications, setting up of calls/video-calls, and internet browsing), and interoperation activities related to interoperation between the OBU device 115 and the edge computing platforms (with such interoperation activities that may be variously distributed between the OBU device 115 and the mobile device 120 depending on specific design options falling within the principles of the present disclosure). Without losing generality, in embodiments in which the OBU device 115 and the mobile device 120 are configured to interact/cooperate to each other to act, as a whole, as the connectable device D, periodic synchronizations between the OBU device 115 and the mobile device 120 may be envisaged to achieve synchronization between data at the OBU device 115 and data at the mobile device 120. Just as an example, any timestamp-based or timestamp-free synchronization techniques may be used.

According to an alternative embodiment (not shown), the connectable device D may be implemented as a stand-alone electronic device capable of running software applications associated with the services, and having connection capabilities to the wireless communication network 105 (for example, by exploiting a respective internal modem). An example of a stand-alone electronic device implementing the connectable device D comprises, but is not limited to, an OBU further provided with mobile connectivity to allow connection to the wireless communication network 105 (and, hence, to the edge computing platforms). Another example of a stand-alone electronic device implementing the connectable device D comprises, but is not limited to, a mobile device (e.g., a smartphone). Thus, in this embodiment, the mobile device is configured to perform both its conventional activities (including, but not limited to, execution of applications, setting up of calls/video-calls, and internet browsing), and activities related to the services delivered/deliverable by the edge computing platforms.

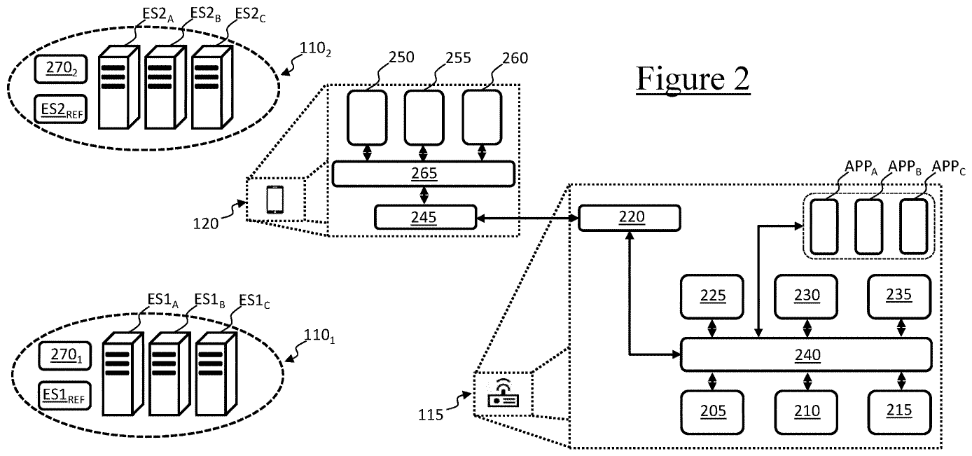

With reference now to FIG. 2, it schematically shows main modules of the system 100 according to embodiments of the present disclosure. Particularly, FIG. 2 schematically shows the main modules of the edge computing platform 110₁,110₂, of the OBU device 115, and of the mobile device 120 that are deemed relevant for the understanding of the present disclosure. In the following, reference will be also made to the connectable device D as a whole, when distinguishing between the OBU device 115 and the mobile device 120 is not relevant for the discussed features (e.g., when the discussed features relate to functional aspects of the connectable device D rather than to implementation aspects thereof).

In the exemplary considered embodiment, the OBU device 115 is configured to run a software application APP_{A} associated with service A, a software application APP_{B} associated with service B, and a software application APP_{C} associated with service C.

According to an embodiment, the OBU device 115 comprises one or more measurement modules for measuring one or more connection parameters indicative of a quality of the connection between the connectable device D and the edge servers. In alternative embodiments (not shown), said one or more measurement modules (or at least a subset thereof) may be provided at the mobile device 120.

According to an embodiment, the connection parameter(s) may comprise a latency (and, preferably, an associated jitter) between the connectable device D and the edge servers. In this embodiment, the measurement module(s) may comprise a latency measurement module 205.

According to an embodiment, as better discussed in the following, the latency measurement module 205 is further configured to perform a check about a connectivity (i.e., the status of a connection or the capability of making a connection), hereinafter connectivity check, between the connectable device D and the edge servers (so as to determine, and preferably store, a connectivity status including, but not limited to, connectivity presence and quality, and connectivity absences/failures and causes thereof). Without losing generality, the connectivity check may be based on PING or other application protocol (for example, TCP application protocol).

According to an embodiment, the connection parameter(s) may comprise a throughput of (or associated with) the edge servers. In this embodiment, the measurement module(s) may comprise a throughput measurement module 210. According to an embodiment, the throughput measurement module 210 is configured to cooperate with a throughput measurement module provided at the edge computing platform side (as discussed in the following).

According to an embodiment, the OBU device 115 comprises a collection module 215. In alternative embodiments (not shown), the collection module 215 may be provided at the mobile device 120.

According to an embodiment, the collection module 215 may be configured to collect network data indicative of performance and/or configurations of the wireless communication network 105.

Examples of network data include, but is not limited to, radio parameters of the wireless communication network 105 (such as Reference Signal Received Power (RSRP) measurements and Reference Signal Received Quality (RSRQ) measurements), and Tracking Area Code (TAC) information (or other location area identifier).

Without losing generality, the radio parameters may be measured by the mobile device 120. According to an embodiment, the radio parameters may be measured autonomously by the mobile device 120 (for example, due to existing operative procedures ruling the connection between the wireless communication network 105 and the mobile device 120), and transmitted (autonomously or on request) to the OBU device 115 (e.g., to the collection module 215). According to an embodiment, the radio parameters may be measured by the mobile device 120 on request by the OBU device 115.

Without losing generality, the TAC information may be transmitted from the wireless communication network 105 to the mobile device 120.

According to an embodiment, the TAC information may be autonomously transmitted from the wireless communication network 105 to the mobile device 120 (for example, due to existing operative procedures ruling the connection between the wireless communication network 105 and the mobile device 120), and forwarded (autonomously or on request) to the OBU device 115 (e.g., to the collection module 215). According to an embodiment, the TAC information may be transmitted from the wireless communication network 105 to the mobile device 120 on request by the OBU device 115.

According to an embodiment, the collection module 215 may be configured to collect position data indicative of a position of the connectable device D within the geographic area.

Examples of position data include, but is not limited to, geolocation information. Without losing generality, the geolocation information may be provided by exploiting GPS and/or GNSS/A-GNSS functionalities of a geolocation module internal to the connectable device D (i.e., internal to the OBU device 115 and/or the mobile device 120) or external thereto.

According to an embodiment, the collection module 215 may be configured to collect usage data indicative of a level of usage of (e.g., hardware and/or software) resources of the mobile device 120.

Examples of usage data includes, but is not limited to, Central Processing Unit (CPU) usage level, and (transmission/reception) buffer usage level. The usage data may be particularly, although not exclusively, advantageous in very-low latency wireless communication networks (such as 5G mobile communication networks), in that a high or relatively high level of usage of the resources of the mobile device 120 (e.g., for performing its conventional activities) may affect the measurements of the connection parameter(s).

According to an embodiment, the OBU device 115 comprises a communication module 220 for allowing physical and/or logical communication interaction between the OBU device 115 and the mobile device 120 based on a proper communication protocol (for example, through the AT command set).

According to an embodiment, the OBU device 115 comprises a Domain Name System (DNS) configuration module 225 for storing and dynamically updating URL/IP address associations of the edge servers. According to an embodiment, each URL/IP address association comprises, for each service deliverable to the connectable device D, a corresponding service URL (for example, a service URL “edge.esA.local” for service A, a service URL “edge.esB.local” for service B, and a service URL “edge.esC.local” for service C), and, associated with the service URL, the IP address of the edge server, among the edge servers configured to deliver that service (in the example at issue, the edge servers ES1_{A},ES2_{A} for service A, the edge servers ES1_{B},ES2_{B} for service B, and the edge servers ES1_{C},ES2_{C} for service C) being selected (and/or addressed by the connectable device D) for the delivery or deliverability of that service. Thanks to the URL/IP address association, the software applications APP_{A},APP_{B},APP_{C} may access the appropriate edge servers for the delivery of the respective services A,B,C without having to manage the respective IP addresses (which makes edge server addressing by the connectable device D easy and fast).

In alternative embodiments (not shown), the DNS configuration module 225 may be provided at the mobile device 120.

According to an embodiment, the OBU device 115 comprises an IP address database 230.

According to an embodiment, IP address database 230 may be configured to store the IP addresses of the edge servers.

According to an embodiment, the IP address database 230 may be configured to store an association (hereinafter, TAC/IP association) between the TAC information and IP addresses of reference edge servers of the edge computing platform (as better discussed in the following). In alternative embodiments (not shown), the IP address database 230 may be provided at the mobile device 120.

According to an embodiment, the OBU device 115 comprises a connectivity module. According to an embodiment, the connectivity module 235 is configured to analyse (e.g., aggregate and/or correlate and/or filter) the (collected) measured connection parameter(s), connectivity failures, position data, usage data, and measured radio parameter(s) (or at least a subset thereof) to obtain corresponding connectivity data indicative of the connectivity status (over the geographic area) to the edge servers.

Amongst other things, the connectivity data may be used for statistical purposes and/or for determining the edge servers which a connectable device in a given position is more likely connectable to, and/or for notifying, at a given position of a connectable device, the absence of connectivity (and, hence, service unavailability) in advance before a service is requested (as better discussed in the following).

In alternative embodiments (not shown), the connectivity module 235 may be provided at the mobile device 120.

According to an embodiment, the OBU device 115 comprises a control module 240.

According to an embodiment, the control module 240 is configured to control and/or coordinate an operation of the software applications APP_{A},APP_{B},APP_{C}, the latency measurement module 205, the throughput measurement module 210, the collection module 215, the communication module 220, the DNS configuration module 225, the IP address database 230, and the connectivity module 235.

Without losing generality, each one among the latency measurement module 205, the throughput measurement module 210, the collection module 215, the communication module 220, the DNS configuration module 225, the IP address database 230, the connectivity module 235, and the control module 240, may be implemented as a respective dedicated module of the OBU device 115, or as an additional functionality of existing modules of the OBU device 115.

According to an embodiment, the mobile device 120 comprises a communication module 245 for allowing physical and/or logical communication interaction between the OBU device 115 and the mobile device 120 based on a proper communication protocol (for example, through the AT command set). According to an embodiment, in order to achieve said physical and/or logical communication between the OBU device 115 and the mobile device 120 (and, hence, between the OBU device 115 and the edge servers), the communication module 220 of the OBU device 115 and the communication module 245 of the mobile device 120 are communicably coupled to each other. According to an embodiment, the communication module 220 of the OBU device 115 and the communication module 245 of the mobile device 120 (or, more generally, the OBU device 115 and the mobile device 120) are communicably coupled to each other by means of a wired connection, for example a Universal Serial Bus (USB) connection. The use of a wired connection (rather than a radio connection) for communicably coupling the OBU device 115 and the mobile device 120 allows avoiding communication delays (which could for example affect the measurements of the connection parameter(s)).

According to an embodiment, the mobile device 120 comprises a plurality of Application Programming Interfaces (in the following, API interfaces) configured to retrieve (e.g., by interfacing with corresponding hardware/software modules of the mobile device 120) the network data and/or the position data and/or the usage data.

According to an embodiment, the mobile device 120 comprises an API interface 250 for retrieving the network data (for example, by interfacing with a cellular module, not shown, of the mobile device 120).

According to an embodiment, the mobile device 120 comprises an API interface 255 for retrieving the position data (for example, by interfacing with a geolocation module, not shown, of the mobile device 120).

According to an embodiment, the mobile device 120 comprises an API interface 260 for retrieving the usage data (for example, by interfacing with the CPU, not shown, of the mobile device 120).

According to an embodiment, the mobile device 120 comprises a control module 265.

According to an embodiment, the control module 265 is configured to control and/or coordinate an operation of the communication module 245, and of the API interfaces 250,255,260.

Without losing generality, each one between the communication module 245 and the control module 265 may be implemented as a respective dedicated module of the mobile device 120, or as an additional functionality of existing modules of the mobile device 120.

According to an embodiment, each edge computing platform 110₁,110₂ comprises a respective throughput measurement module 270₁,270₂ for measuring the throughput at the respective edge servers ES1_{A}-ES1_{C}, ES2_{A}-ES2_{C}. According to an embodiment, each throughput measurement module 270₁,270₂ is configured to perform throughput measurements by cooperation with the throughput measurement module 210 at the connectable device D (at the OBU module 115, in the example at issue).

According to an embodiment, each edge computing platform 110₁,110₂ comprise a respective reference edge server ES1_{REF}, ES2_{REF}.

According to an embodiment, each reference edge server ES1_{REF}, ES2_{REF} may be used for performing the connectivity check at the respective edge computing platform 110₁,110₂ (i.e., so that the resulting connectivity status determined for the reference edge server of the respective edge computing platform 110₁,110₂ may be assumed to be indicative of the connectivity status for all the edge servers of that edge computing platform 110₁,110₂).

According to an embodiment, each reference edge server ES1_{REF}, ES2_{REF} may be configured as a protocol termination server used for connectivity checks and/or latency measurements based on protocols different from the PING protocol (as better discussed in the following).

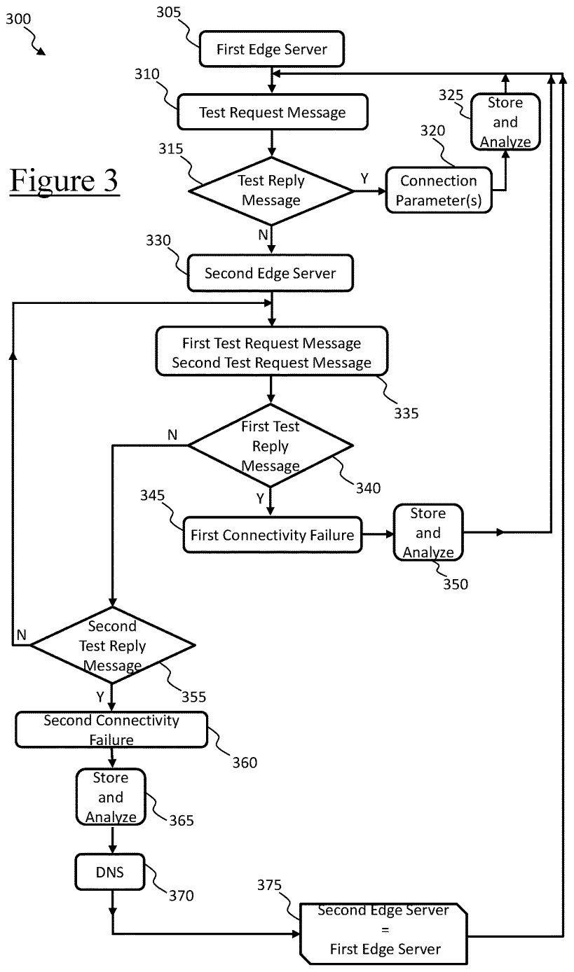

With reference now to FIG. 3, it shows an activity diagram of a method 300 according to embodiments of the present disclosure. Particularly, the activity diagram describes the flow of activities relating to exemplary embodiments of the present disclosure. In this respect, each node of the activity diagram may correspond to one or more executable instructions for implementing the specified logical function(s) on a relevant hardware/software component.

Broadly speaking, the method 300 is aimed at managing the delivery or deliverability of a service (for example, one or more among the services A,B,C) to a connectable device (such as the connectable device D) moving or movable within the geographic area covered by a wireless communication network (such as the wireless communication network 105), wherein the geographic area comprises a plurality of edge servers for the delivery of the service (such as the edge servers ES1_{A}-ES1_{C} associated with the edge computing platform 110₁, and the edge servers ES2_{A}-ES2_{C} associated with the edge computing platform 110₂).

In the following, the method 300 will be discussed by making exemplary reference to delivery or deliverability of service A. Without losing generality, the method steps discussed in the following in connection to the delivery or deliverability of service A may be equivalently performed for the delivery or deliverability of other services (such as services B and/or C). Without losing generality, the method steps for the delivery or deliverability of other services (such as services B and/or C) may for example be performed concurrently, at least partially concurrently, or as separate and independent instances with respect to the method steps for the delivery or deliverability of service A.

According to an embodiment, the method 300 comprises identifying a first one of the plurality of edge servers (for the delivery or deliverability of service A) which the connectable device D is connectable to (action node 305). Without losing generality, the first edge server may be an initial edge server, i.e. the edge server to which the connectable device D is connectable or connected at a first running of the method 300 (for example, at a start of a path of the connectable device D within the geographic area).

For the purposes of the present disclosure, by edge server which a connectable device is connectable to, it is herein meant that the connectable device is connectable to that edge server (or, equivalently, that the edge server is reachable by the connectable device), or, otherwise stated, that the connectable device is capable of making a connection to the edge server.

For the purposes of the present disclosure, by edge server which a connectable device is connectable to for the delivery or deliverability of a service, it is herein meant that the connectable device is connectable to that edge server with connection parameters (or at least a subset thereof) that are compliant with predefined requirements for the delivery of that service. Just as a non-exhaustive example, an edge server is deemed reachable by a connectable device for the delivery or deliverability of a real-time service (such as in Vehicle-to-everything (V2X) applications) if the latency between the edge server and the connectable device is lower than a predefined latency.

Let be assumed, just as an example, that the first edge server is the edge server ES1_{A}.

According to an embodiment, the identification of the first edge server ES1_{A} may be based on the connectivity data provided by the connectivity module 235 of the OBU device 115, and on a current position of the connectable device D (the current position of the connectable device D being for example determined by the API interface 255 of the mobile device 120 by interaction with the GPS module thereof).

According to an embodiment, the identification of the first edge server ES1_{A} may be based on the TAC information associated with the current position of the connectable device D within the geographic area. Just as an example, based on the TAC/IP association stored in the IP address database 230, the first edge server ES1_{A} may be identified (and addressed) by intermediation of the associated reference edge server ES1_{REF}. Identification based on the TAC information is simple and involves low computation complexity, contrary to known solutions of identification of a reference server based on geographical coordinates of a user (which, instead, require definition of an interest zone covered by the edge computing platform, identification of a user zone corresponding to the geographical coordinates of the user, and individuation of the reference server by analysing the interest zone and the user zone).

According to an embodiment, the identification of the first edge server ES1_{A} based on the TAC information may be additional or alternative to the identification of the first edge server ES1_{A} based on the connectivity data. Just as an example, the identification of the first edge server ES1_{A} based on the TAC information may be performed, for a given position of the connectable device D, in case of absent or outdated connectivity data associated with that position of the connectable device D.

According to an embodiment, upon identification of the first edge server ES1_{A}, the IP address of the first edge server ES1_{A} is retrieved (e.g., from the IP address database 230) and is associated with the corresponding service URL. In the considered example, the IP address of the first edge server ES1_{A} is associated with the service URL “edge.esA.local”.

According to an embodiment, the URL/IP address association is performed at the DNS configuration module 225.

According to an embodiment, the method 300 comprises transmitting, through the wireless communication network 105, a test request message to check if the first edge server ES1_{A} is (still) reachable by the connectable device D as a result of the connectable device D moving or being movable within the geographic area (action node 310)—connectivity check. According to an embodiment, the test request message may be transmitted from the connectable device D (for example, by exploiting functionalities of the latency measurement module 205) to the first edge server ES1_{A} (or, in alternative embodiments, to the respective reference edge server ES1_{REF}).

According to an embodiment, the test request message (as well as a respective test reply message possibly received at the connectable device D in response thereto) comprises Internet Control Message Protocol (ICMP) packets.

Just as an example, transmission of the test request message and reception of the test reply message may be performed based on PING protocol.

Just as another example, transmission of the test request message and reception of the test reply message may be performed based on a round-trip delay time measurement protocol. An example of a round-trip delay time measurement protocol is disclosed in the International Application No. PCT/EP2022/079289.

Without losing generality, transmission of the test request message and reception of the test reply message may be performed based on any suitable protocol.

As mentioned above, depending on the used protocol, the reference edge server ES1_{REF} may be configured as a corresponding protocol termination server.

According to an embodiment, the method 300 comprises, if a test reply message is received from the first edge server ES1_{A} (or, in alternative embodiments, from the respective reference edge server ES1_{REF}) in response to the test request message (exit branch Y of decision node 315), which means that the first edge server ES1_{A} is reachable by the connectable device D, determining or measuring the connection parameter(s) indicative of the quality of the connection between the connectable device D and the first edge server ES1_{A} (action node 320).

As mentioned above, according to an embodiment, the measured connection parameter(s) comprise one or more among latency, jitter and throughput of the first edge server ES1_{A}.

Just as an example, the latency of the first edge server ES1_{A} (as well as the associated jitter) may be determined or measured (e.g., by the latency measurement module 205) based on a time between transmission of the test request message and reception of the test reply message. Without losing generality, the times of transmission of the test request message and of reception of the test reply message may be determined based on respective timestamps associated therewith.

According to an embodiment, the latency of the first edge server ES1_{A} (as well as the associated jitter) may be determined or measured by the latency measurement module 205.

According to an embodiment, the throughput of the first edge server ES1_{A} may be determined or measured by the throughput measurement modules 210,270₁.

According to an embodiment, the method 300 comprises collecting and storing (e.g., at the collection module 215) the measured connection parameter(s) together with one or more among the position data indicative of the position of the connectable device D, the network data of the wireless communication network 105 in that position, and the usage data indicative of the level of usage of the resources of the mobile device 120 (action node 325). As discussed in the foregoing, according to an embodiment the network data, the position data and the usage data may be determined at the API interfaces 250,255,260, respectively, of the mobile device 120. According to an embodiment, the network data, the position data and the usage data may be determined at the API interfaces 250,255,260, respectively, of the mobile device 120, and retrieved by the collection module 215 on a periodic basis or on an aperiodic basic (for example, upon measurement of the connection parameter(s)).

According to an embodiment, the method 300 comprises analyzing (e.g., at the analysis module 235) the collected and stored measured connection parameter(s), position data, network data, and usage data to update the connectivity data (action node 325). Without losing generality, the analysis of the connection parameter(s), position data, network data, and usage data allows determining, for the position (within the geographic area) indicated by the position data, the connectivity status and how it is affected by the wireless communication network 105 and/or by the connectable device D.

According to an embodiment, not shown, the method 300 further comprises, based on the updated connectivity data, determining the availability or the unavailability of the service A, i.e., the deliverability or undeliverability of the service A from the first edge server ES1_{A} and the connectable device D, and providing an indication thereof. Just as an example, the deliverability of the service A from the first edge server ES1_{A} and the connectable device D may be determined if the latency between the first edge server ES1_{A} and the connectable device D is lower than an admitted latency being admitted for the delivery of the service A, otherwise the undeliverability of the service A may be determined. According to an embodiment, the indication of the availability (or deliverability) or unavailability (or undeliverability) of the service A may comprise a sound and/or light notification to the user (for example, through the OBU device 115 or the mobile device 120), for example for the purpose of informing the user. According to an embodiment, the indication of the availability (or deliverability) or unavailability (or undeliverability) of the service A may comprise one or more notices or reports to the corresponding software application APP_{A}, for example for purposes of connectivity data update, and/or software application optimization and/or OBU device internal processes.

According to an embodiment, the connectivity check of nodes 310-325 is iterated as long as the first edge server ES1_{A} is reachable by the connectable device D. This is conceptually shown in the figure by loop connection between action node 325 and action node 310. According to an embodiment, each connectivity check is performed on a periodic basis (for example, after a predetermined time interval, for example of the order of one or more seconds), or on an aperiodic basis (for example, after a predetermined time interval from reception of the test reply message, or after a predetermined time interval from measurement of the connection parameter(s) and/or from retrieval of the network data and/or position data and/or usage data). According to an embodiment, the predetermined time interval is controlled (e.g., by the control module 240) depending on one or more factors or conditions. According to an embodiment, the predetermined time interval is controlled (e.g., by the control module 240) depending on one or more radio network conditions: just as an example, the predetermined time interval may be decreased in case of bad or relatively bad radio network conditions, or the predetermined time interval may be increased in case of good or relatively good radio network conditions).

According to an embodiment, the method 300 comprises, if no test reply message is received (e.g., within a prescribed time interval from transmission of the test request message) in response to the test request message (exit branch N of decision node 315), identifying a second one of the edge servers that may be reachable by the connectable device D instead of the first edge server ES1_{A} as a result of the connectable device D moving or being movable within the geographic area (action node 330).

Let it be assumed, just as an example, that the second edge server is the edge server ES2_{A}.

According to an embodiment, the identification of the second edge server ES2_{A} may be based on the current position of the connectable device D, and on the connectivity data associated with that position and provided by the connectivity module 235.

According to an embodiment, the identification of the second edge server ES2_{A} may be based on the TAC information associated with the current position of the connectable device D within the geographic area. Just as an example, based on the TAC/IP association stored in the IP address database 230, the second edge server ES2_{A} may be identified (and addressed) by intermediation of the associated reference edge server ES2_{REF}.

According to an embodiment, the identification of the second edge server ES2_{A} based on the TAC information may be additional or alternative to the identification of the second edge server ES2_{A} based on the connectivity data. Just as an example, the identification of the second edge server ES2_{A} based on the TAC information may be performed, for a given position of the connectable device D, in case of absent or outdated connectivity data associated with that position of the connectable device D.

According to an embodiment, not shown, the method 300 further comprises, if no test reply message is received in response to the test request message (exit branch N of decision node 315), providing an indication about the unavailability of the service A. According to an embodiment, the indication of the unavailability of the service A may comprise a sound and/or light notification to the user, for example for the purpose of informing the user. According to an embodiment, the indication of the unavailability of the service A may comprise one or more notices or reports to the corresponding software application APP_{A}, for example to make the service A unavailable in advance before it is requested. Without losing generality, the indication of the unavailability of the service A may comprise one or more notices or reports to the corresponding software application APP_{A}, for example for purposes of connectivity data update, and/or software application optimization and/or OBU device internal processes.

According to an embodiment, the method 300 comprises, upon identification of the second edge server ES2_{A}, transmitting a first test request message to the first edge server ES1_{A} and a second test request message to the second edge server ES2_{A} (action node 335). A timing of the transmission of the first test request message to the first edge server ES1_{A} and of the transmission of second test request message to the second edge server ES2_{A} is not limiting for the present disclosure. Without losing generality, the transmission of the first test request message to the first edge server ES1_{A} and the transmission of the second test request message to the second edge server ES2_{A} may be performed concurrently, or after a prescribed time limit from one another.

According to an embodiment, the first test request message transmitted to the first edge server ES1_{A} (as well as a respective first test reply message possibly received at the connectable device D in response thereto) comprises Internet Control Message Protocol (ICMP) packets.

Just as an example, transmission of the first test request message and reception of the first test reply message may be performed based on the PING protocol.

Just as another example, transmission of the first test request message and reception of the first test reply message may be performed based on a round-trip delay time measurement protocol. An example of a round-trip delay time measurement protocol is disclosed in the above-mentioned International Application No. PCT/EP2022/079289.

According to an embodiment, the second test request message transmitted to the second edge server ES2_{A} (as well as a respective second test reply message possibly received from the second edge server ES2_{A} in response thereto) comprises Internet Control Message Protocol (ICMP) packets.

Just as an example, transmission of the second test request message and reception of the second test reply message may be performed based on the PING protocol.

Just as another example, transmission of the second test request message and reception of the second test reply message may be performed based on a round-trip delay time measurement protocol. An example of a round-trip delay time measurement protocol is disclosed in the above-mentioned International Application No. PCT/EP2022/079289.

Without losing generality, transmission of the first test request message and reception of the first test reply message and/or transmission of the second test request message and reception of the second test reply message may be performed based on any suitable protocol.

As mentioned above, depending on the used protocol(s), the reference edge servers ES1_{REF}, ES2_{REF} may be configured as corresponding protocol termination servers.

According to an embodiment, the method 300 comprises, if a first test reply message is received in response to the first test request message (exit branch Y of decision node 340), determining that a first connectivity failure only temporarily affected the connection to the first edge server ES1_{A} (action node 345), and, hence that service A is still deliverable by the first edge server ES1_{A}.

Thus, the first connectivity failure represents a temporary connectivity failure between the first edge server ES1_{A} and the connectable device D.

According to an embodiment, said determining that a first connectivity failure has affected the first edge server ES1_{A} further comprises providing an indication of said first connectivity failure, for example by sound and/or light notification to the user (e.g., through the OBU device 115 or the mobile device 120), for example for the purpose of informing the user, and/or by one or more notices or reports to the corresponding software application APP_{A}, for example for purposes of connectivity data update, and/or software application optimization and/or OBU device internal processes.

According to an embodiment, the indication of the first connectivity failure may comprise a quality indication of the first connectivity failure. Just as an example, the quality indication of the first connectivity failure may comprise an advisory of an end of a temporary connectivity failure between the first edge server ES1_{A} and the connectable device D.

According to an embodiment, the indication of the first connectivity failure may comprise a quantitative indication of the first connectivity failure. Just as an example, the quantitative indication of the first connectivity failure may comprise an indication of a duration of the first connectivity failure.

Just as an example, the duration of the first connectivity failure (or the indication thereof) may be based on a time between a last test reply message received from the first edge server ES1_{A} (e.g., the last test reply message received before exiting the iterations of nodes 310-325) and reception of the first test reply message. Without losing generality, the times of reception of said last test request message and of said first test reply message may be determined based on respective timestamps associated therewith.

According to an embodiment, the method 300 comprises, similarly to action node 325, collecting and storing (e.g., at the collection module 215) the (e.g., qualitative and/or quantitative) indication of the first connectivity failure, and accordingly updating the connectivity data (action node 350). According to an embodiment, the (e.g., qualitative and/or quantitative) indication of the first connectivity failure may be collected and stored together with one or more among the position data, the network data, and the usage data.

In the exemplary considered embodiment, upon determination of the first connectivity failure, no measurements of the connection parameter(s) indicative of the quality of the connection between the connectable device D and the first edge server ES1_{A} takes place: indeed, in the exemplary considered embodiment, the measurements of the connection parameter(s) are performed as part of the connectivity check of nodes 310-325.

According to an alternative embodiment, not shown, upon determination of the first connectivity failure, the method 300 may further comprise measuring the connection parameter(s) indicative of the quality of the connection between the connectable device D and the first edge server ES1_{A}: in this embodiment, the (e.g., qualitative and/or quantitative) indication of the first connectivity failure may be collected and stored together with the measured connection parameter(s).

According to an embodiment, the connectivity check from node 310 is iterated for the first edge server ES1_{A} (as conceptually illustrated in the figure by loop connection between action node 350 and action node 310). According to an embodiment, each connectivity check is performed on a periodic basis, or on an aperiodic basis (for example, after a predetermined time interval from determination of the first connectivity failure, or after a predetermined time interval from retrieval of the corresponding network data and/or position data and/or usage data).

According to an embodiment, the method 300 comprises, if no first test reply message is received from the first edge server ES1_{A} in response to the first test request message (exit branch N of decision node 340), and if a second test reply message is received from the second edge server ES2_{A} in response to the second test request message (exit branch Y of decision node 355), determining that a second connectivity failure has affected the connection to the first edge server ES1_{A} due to service deliverabilty being passed from the first edge server ES1_{A} to the second edge server ES2_{A} (action node 360).

According to an embodiment, said determining that a second connectivity failure has occurred further comprises providing an indication of the second connectivity failure, for example by sound and/or light notification to the user (e.g., through the OBU device 115 or the mobile device 120), for example for the purpose of informing the user, and/or by one or more notices or reports to the corresponding software application APP_{A} (for example, for purposes of connectivity data update, and/or software application optimization and/or OBU device internal processes).

According to an embodiment, the indication of the second connectivity failure may comprise a quality indication of the second connectivity failure. Just as an example, the quality indication of the second connectivity failure may comprise an advisory of the service deliverabilty being passed from the first edge server ES1_{A} to the second edge server ES2_{A}.

According to an embodiment, the indication of the second connectivity failure may comprise a quantitative indication of the second connectivity failure. Just as an example, the quantitative indication of the second connectivity failure may comprise an indication of a duration of the second connectivity failure.

Just as an example, the duration of the second connectivity failure (or the indication thereof) may be based on a time between a last test reply message received from the first edge server ES1_{A} and reception of the second test reply message. Without losing generality, the times of reception of the last reply message and of reception of the second test reply message may be determined based on respective timestamps associated therewith.

According to an embodiment, the method 300 comprises, similarly to action node 350, collecting and storing (e.g., at the collection module 215) the (e.g., qualitative and/or quantitative) indication of the second connectivity failure, together with the position data, the network data, and the usage data, and accordingly update the connectivity data (action node 365).

In the exemplary considered embodiment, upon determination of the second connectivity failure, no measurements of the connection parameter(s) indicative of the quality of the connection between the connectable device D and the second edge server ES2_{A} takes place: indeed, in the exemplary considered embodiment, the measurements of the connection parameter(s) for the second edge server ES2_{A} are intended to be performed during the corresponding connectivity check of the second edge server ES2_{A} at the following repetition of the method from step 310 (as discussed in the following).

According to an alternative embodiment, not shown, upon determination of the second connectivity failure, the method 300 may further comprise measuring the connection parameter(s) indicative of the quality of the connection between the connectable device D and the second edge server ES2_{A}: in this embodiment, the (e.g., qualitative and/or quantitative) indication of the second connectivity failure may be collected and stored together with the measured connection parameter(s).

According to an embodiment, the connectivity check of nodes 335-355 is iterated as long as no first test reply message is received from the first edge server ES1_{A} (exit branch N of decision node 340) and no second test reply message is received from the second edge server ES2_{A} (exit branch N of decision node 355), i.e., as long as both the first edge server ES1_{A} and the second edge server ES2_{A} are not reachable by the connectable device D. This is conceptually shown in the figure by loop connection between exit branch N of decision node 355 and action node 335.

According to an embodiment, each connectivity check is performed on a periodic basis, or on an aperiodic basis (for example, after a predetermined time interval from transmission of the first and second test request messages).

According to an embodiment, not shown, after a predefined number of iterations of the connectivity checks of nodes 335-355, the method 300 may end, restart, or continue from identification of a different second edge server (i.e., from action node 330).

According to an embodiment, not shown, if both the first test reply message is received from the first edge server ES1_{A} in response to the first test request message (exit branch Y of decision node 340), and the second test reply message is received from the second edge server ES2_{A} in response to the second test request message (exit branch Y of decision node 355), occurrence that may arise when, for example, the connectable device D is in a position of the geographic area reachable by both the edge computing platforms 110₁,110₂ and/or in presence of connection procedure anomalies, the method 300 may comprise repeating the connectivity check (from action node 335), in that the uncertainty may meanwhile have resolved due to connectable device movement), or selecting the edge server (between the first edge server ES1_{A} and the second edge server ES2_{A}) that is suitable or best suitable for the delivery of the service based on the connectivity data, or, in case that no connectivity data is available to this purpose, on real-time measurements of the connection parameter(s).

According to an embodiment, the method 300 comprises, in response to the service deliverabilty having passed from the first edge server ES1_{A} to the second edge server ES2_{A}, performing an update of the corresponding URL/IP address association (action node 370). According to an embodiment, the update of the URL/IP address association comprises associating the IP address of the second edge server ES2_{A} with the corresponding service URL. In the considered example, the update of the URL/IP address associations comprises associating the IP address of the second edge server ES2_{A} with the service URL “edge.esA.local”.

According to an embodiment, the URL/IP address association updating is performed at the DNS configuration module 225.

According to an embodiment, the method 300 comprises repeating nodes 310-370 for the second edge server ES2_{A} (i.e., with the second edge server ES2_{A} that, during such repetition, acts as the first edge server ES1_{A}, as conceptually illustrated in the figure by the logical node 375 and by connection thereof to action node 310).

Naturally, in order to satisfy local and specific requirements, a person skilled in the art may apply to the disclosure described above many logical and/or physical modifications and alterations. More specifically, although the present disclosure has been described with a certain degree of particularity with reference to preferred embodiments thereof, it should be understood that various omissions, substitutions and changes in the form and details as well as other embodiments are possible. In particular, different embodiments of the disclosure may even be practiced without the specific details set forth in the preceding description for providing a more thorough understanding thereof; on the contrary, well-known features may have been omitted or simplified in order not to encumber the description with unnecessary details. Moreover, it is expressly intended that specific elements and/or method steps described in connection with any disclosed embodiment of the disclosure may be incorporated in any other embodiment.

More specifically, the present disclosure lends itself to be implemented through an equivalent method (by using similar steps, removing some steps being not essential, or adding further optional steps); moreover, the steps may be performed in different order, concurrently or in an interleaved way (at least partly).

1. Method for managing the deliverability of a service to a connectable device moving or movable within a geographic area covered by a wireless communication network and comprising a plurality of edge computing nodes for the delivery of the service, the method comprising performing the following steps a)-f₂):
a) identifying a first one of the plurality of edge computing nodes which the connectable device is connectable to;
b) transmitting, through the wireless communication network, a test request message to the first edge computing node to check if the connectable device is still connectable to the first edge computing node as a result of the connectable device moving or being movable within the geographic area;
c₁) if a test reply message is received from the first edge computing node in response to the test request message, measuring at least one connection parameter indicative of a quality of the connection between the connectable device and the first edge computing node, and performing step b);
c₂) if no test reply message is received from the first edge computing node in response to the test request message,
d) identifying a second one of the plurality of edge computing nodes which the connectable device is connectable to instead of the first edge computing node as a result of the connectable device moving or being movable within the geographic area;
e) transmitting a first test request message to the first edge computing node and a second test request message to the second edge computing node, and
f₁) if a first test reply message is received from the first edge computing node in response to the first test request message, determining that a first connectivity failure temporarily affected the connection to the first edge computing node whereby the service is still deliverable by the first edge computing node, and providing an indication of said first connectivity failure; or
f₂) if a second test reply message is received from the second edge computing node in response to the second test request message, determining that a second connectivity failure has affected the connection to the first edge computing node due to service deliverabilty being passed from the first edge computing node to the second edge computing node, and providing an indication of said second connectivity failure.

2. The method according to claim 1, wherein step f₁) further comprises performing step b), and step f₂) further comprises performing step b) with the second edge computing node acting as the first edge computing node.

3. The method according to claim 1, wherein the at least one connection parameter comprises one or more among latency, jitter and throughput of the first edge computing node.

4. The method according to claim 3, wherein the latency of the first edge computing node is determined based on a time between transmission of the test request message and reception of the test reply message.

5. The method according to claim 1, wherein said providing an indication of said first connectivity failure comprises providing an indication of a duration of said first connectivity failure based on a time between a last test reply message received from the first edge computing node and reception of the first test reply message.

6. The method according to claim 1, wherein said providing an indication of said second connectivity failure comprises providing an indication of a duration of said second connectivity failure based on a time between a last test reply message received from the first edge computing node and reception of the second test reply message.

7. The method according to claim 1, further comprising, if no first test reply message from the first edge computing node is received in response to the first test request message, and no second test reply message from the second edge computing node is received in response to the second test request message, performing step e).

8. The method according to claim 1, wherein step c₁) further comprises storing the measured at least one connection parameter together with position data indicative of a position of the connectable device and one or more measured radio parameters of the wireless communication network in that position, step f₁) further comprises storing the indication of said first connectivity failure together with the position data and with the one or more measured radio parameters, and step f₂) further comprises storing the indication of said second connectivity failure together with the position data and with the one or more measured radio parameters.

9. The method according to claim 8, wherein at least one between said identifying a first one of the plurality of edge computing nodes and said identifying a second one of the plurality of edge computing nodes is based on the stored measured at least one connection parameter, the stored indications of said first connectivity failures, the stored indications of said second connectivity failures, and a current position of the connectable device within the geographic area.

10. The method according to claim 1, wherein at least one between said identifying a first one of the plurality of edge computing nodes and said identifying a second one of the plurality of edge computing nodes is based on a Tracking Area Code associated with the current position of the connectable device within the geographic area.

11. The method according to claim 1, wherein at least one among the test request and reply messages, the first test request and reply messages, and the second test request and reply messages comprise Internet Control Message Protocol (ICMP) packets.

12. The method according to claim 1, wherein at least one among transmission of the test request message and reception of the test reply message, transmission of the first test request message and reception of the first test reply message, and transmission of the second test request message and reception of the second test reply message is performed based on PING protocol.

13. A connectable device movable within a geographic area covered by a wireless communication network and comprising a plurality of edge computing nodes for the delivery of a service to the connectable device, the connectable device being configured to perform the following steps a)-f₂):
a) identifying a first one of the plurality of edge computing nodes which the connectable device is connectable to;
b) transmitting, through the wireless communication network, a test request message to the first edge computing node to check if the connectable device is still connectable to the first edge computing node as a result of the connectable device moving or being movable within the geographic area;
c₁) if a test reply message is received from the first edge computing node in response to the test request message, measuring at least one connection parameter indicative of a quality of the connection between the connectable device and the first edge computing node, and performing step b);
c₂) if no test reply message is received from the first edge computing node in response to the test request message,
d) identifying a second one of the plurality of edge computing nodes which the connectable device is connectable to instead of the first edge computing node as a result of the connectable device moving or being movable within the geographic area;
e) transmitting a first test request message to the first edge computing node and a second test request message to the second edge computing node, and
f₁) if a first test reply message is received from the first edge computing node in response to the first test request message, determining that a first connectivity failure temporarily affected the connection to the first edge computing node whereby the service is still deliverable by the first edge computing node, and providing an indication of said first connectivity failure; or
f₂) if a second test reply message is received from the second edge computing node in response to the second test request message, determining that a second connectivity failure has affected the connection to the first edge computing node due to service deliverabilty being passed from the first edge computing node to the second edge computing node, and providing an indication of said second connectivity failure.
